(19) United States
(12) Patent Application Publication
(10) Pub. No.: US 2009/0144262 A1
(43) Pub. Date: Jun. 4, 2009

(54) SEARCH QUERY TRANSFORMATION USING DIRECT MANIPULATION

(75) Inventors: Ryen William White, Kirkland, WA (US); Mikhail Bilenko, Bellevue, WA (US); Robert L. Rounthwaite, Fall City, WA (US); Daniel S. Morris, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/949,773

(22) Filed: Dec. 4, 2007

(51) Int. Cl. G06F 17/30

(52) U.S. Cl. 707/5; 707/E17.108

(57) ABSTRACT

A search query transformation system and method for transforming and refining a search query are described. Embodiments of the system and method use various graphical components and controls. Direct manipulation ensures that the searcher is driving the changes in the search queries using a pointing device. Embodiments of the search query transformation system and method include a search query re-weighting user interface (UI) component for graphically adjusting and re-weighting weights of search terms, and a search query term replacement UI component for graphically replacing a search term in a query or add a synonym to the query. Embodiments of the system and method also include a search query suggestion component, which provides query revision recommendations to a searcher that are tailored to the direct manipulation query refinement interface.

### BACKGROUND

It is subjectively clear that some users are “better” than others at searching the Web. Some people are skilled searchers who have searched the Web hundreds of times per day for the last ten years, while other searchers are novices who have only searched the Web once or twice. Being “good at Web searching”, for purposes of this document, is independent of a searcher's domain-specific knowledge, and does not mean that the searcher has a great deal of knowledge about the material for which he is searching. Instead, a user's general skill level and efficiency at searching the Web dictates whether the searcher is a good searcher. For example, certain searchers are better at search tasks such as formulating search queries, quickly evaluating search results, and integrating information from multiple search systems.

Formulating search queries is an important problem that has been studied extensively in recent years. It has been shown that the inclusion of advanced operators offered by Web search engines in queries can lead to improved search performance. These advanced operators include plus (+), minus (−), double quotes (“ ”), “site:” (an operator that restricts the search to a particular host or Web domain), and “weight:” (an operator that expresses the importance or weight of a query term relative to other query terms). One problem, however, is that novice users generally do not use these operators. This is because they may not be aware of the existence of advanced operators or may not understand the positive impact that the utilization of advanced syntax can have on performing productive searches.

One of the most important aspects of the search query formulation process is the ability to effectively transform or refine a search query. Typically, a searcher desires to refine a search query if relevant or desired results are not retrieved with the initial query. However, novice searchers frequently have difficulty refining a query following an unsuccessful search. Another problem is that query refinement typically requires extensive typing and text manipulation, which is difficult when using mobile devices or pen-based computers. This is because typing on these devices generally is an extremely slow operation, and careful replacement of text within a text field is even more difficult. As mobile searches become more prevalent, this limits the utility of the traditional text-based mechanisms for query refinement.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the search query transformation system and method include refining an initial search query using a graphical user interface. Search transformation and refinement operations as well as advanced search operators are represented graphically to allow a searcher to refine the initial search query quickly and easily. Because the search transformation is graphical, direct manipulation can be used. Direct manipulation allows graphical objects to be directly manipulated using rapid, reversible, and incremental actions that loosely correspond to the physical world. In other words, direct manipulation means that the searcher is making or driving the changes in the search queries through their interaction with the system.

Supporting search query transformation through direct manipulation is valuable for a number of reasons. In particular using this mechanism, query quality can be improved for novice searchers, and query refinement time can be reduced for mobile users and novice searchers. Moreover, direct manipulation shields a searcher from advanced query syntax, which allows him to focus more on what he wants rather than how to express himself in a way that can be directly interpreted by the search engine. In other words, direct manipulation as used in embodiments of the search query transformation system and method make the search query transformation and revision intuitive to even novice searchers who are unfamiliar with the subtleties of searching the Web.

Embodiments of the search query transformation system and method include a search query re-weighting user interface (UI) component, a search query term replacement UI component, and a search query suggestion component. The search query re-weighting UI component uses graphical UI controls to adjust and re-weight the weights of search terms and adjust grouping of the search terms. The re-weighting UI component enables the formulation of syntactically complex query statements that incorporate advanced search operators. This component both shields the searcher from the potentially confusing underlying search engine mechanics and leverages familiar interface elements to empower searchers. More generally, graphical controls are used along with direct manipulation to allow searchers to create complex, syntactically-rich queries that use advanced operators without the need to manually manipulate the text of the search query. This visualization of a search query formulation creates a representation that may be better understood by the 80% of searchers who are novice searchers and have never used advanced search operators.

For example, some embodiments use sliders to graphically represent the weight of each search term in the search query. Moreover, graphical controls allow a searcher to insert and remove search terms with the touch of a button. Some embodiments include graphical controls for phrase creation and division, such that the searcher can graphically put search terms in quotes to create a phrase or divide search terms out of a phrase. Other embodiments include the visualization of search term weights in search results. For example, visual weight bars can be placed next to each entry in a search result list to allow the searcher to compare how well each search term in a query matched up with the particular search result. This allows the searcher to know how to best refine the initial search query to obtain more relevant search results. Embodiments of the re-weighting UI component also include various techniques for the rapid re-querying of transformed or refined search queries. In general, rapid re-querying provides virtually instantaneous reordering of search results based on a revised search query by pre-fetching and pre-caching a number of results.

The search query term replacement UI component allows a searcher to use graphical controls to replace a search term in a query or add a synonym to the query. In some embodiments a synonym tree is used. The synonym tree is a UI interface component that allows rapid replacement of individual search terms and exploration of alternative queries. This component eases the process of query refinement for novice searchers, and eases the process of selecting new query terms for searchers using mobile or pen-based devices (since no typing is required).

The search query suggestion component provides query refinement recommendations to a searcher that are specifically tailored to the direct-manipulation interface presented in this document. In some embodiments, suggestions are based on expert searcher recommendations, which use interaction log data from search engine query logs and from user interaction with the embodiments of the system and method. These recommendations provide a searcher with knowledge of how an expert searcher would refine the search query at hand and the settings that the expert searcher would make to the components and graphical controls. In some embodiments another source of recommendations is a database of popular searches, which uses the same type of data except from all searchers (not just expert searchers) that may have entered the same or similar queries. A searcher is provided with recommendations to refine a search query using embodiments of the proposed system and method, based on what a majority of searchers with a possibly similar information need have done in the past.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating the search query transformation system disclosed herein implemented in a search engine environment.

FIG. 2 is a block diagram illustrating an exemplary implementation of the search query transformation system shown in FIG. 1.

FIG. 3 illustrates a first embodiment of the search query re-weighting user interface component that utilizes slider controls.

FIG. 4 illustrates the first embodiment of the search query re-weighting user interface component shown in FIG. 3 after using the phrase creation button to link two terms into a single phrase.

FIG. 5 illustrates a search term weight visualization component implemented in a web browser along with search results and the first embodiment of the search query re-weighting user interface component shown in FIG. 3.

FIG. 6 illustrates a second embodiment of the search query re-weighting user interface component that utilizes bar graph.

FIG. 7 illustrates a third embodiment of the search query re-weighting user interface component that utilizes a pie chart.

FIG. 8 illustrates one embodiment of the search query term replacement UI components integrated into a search text box containing a synonym tree functionality.

FIG. 9 illustrates the embodiment of FIG. 8 during the search query refinement process.

FIG. 10 illustrates an example of a suitable computing system environment in which embodiments of the search query transformation system and method shown in FIGS. 1-9 may be implemented.

### DETAILED DESCRIPTION

In the following description of embodiments of the search query transformation system and method reference is made to the accompanying drawings, which form a part thereof, and in which is shown by way of illustration a specific example whereby embodiments of the search query transformation system and method may be practiced. It is to be understood that other embodiments may be utilized and structural changes may be made without departing from the scope of the claimed subject matter.

### I. System and Operational Overview

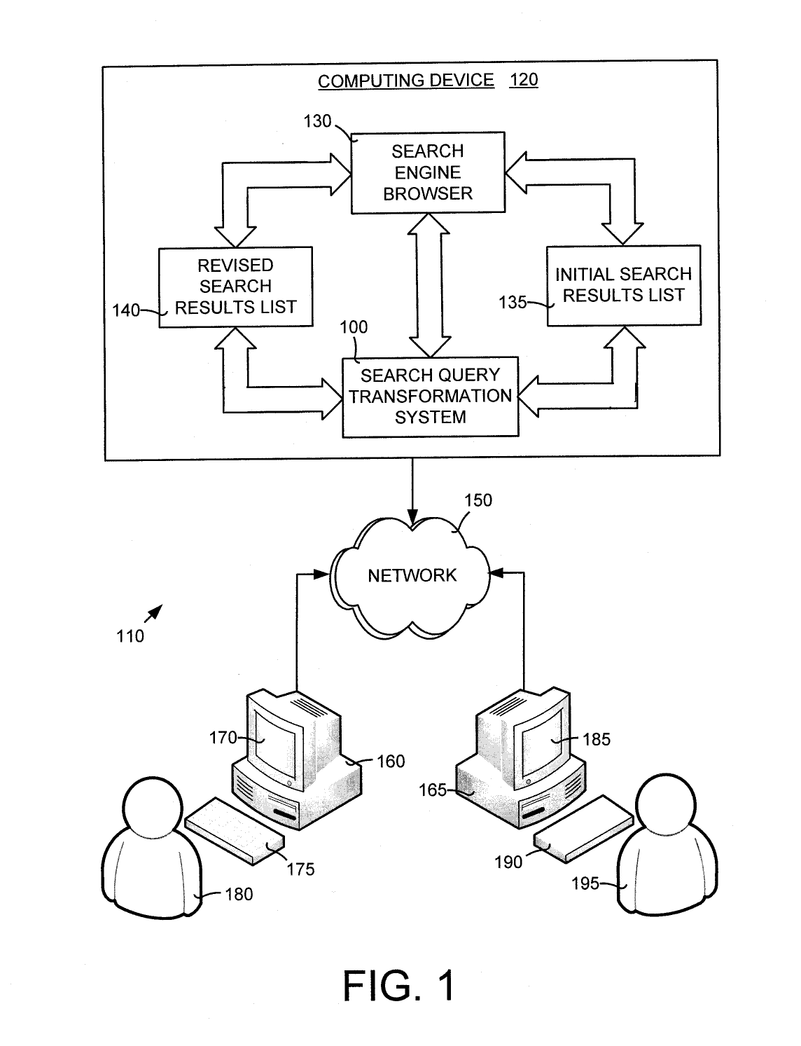

FIG. 1 is a block diagram illustrating the search query transformation system disclosed herein implemented in a search engine environment. It should be noted that the implementation shown in FIG. 1 is only one of many implementations that are possible. Referring to FIG. 1, the search query transformation system 100 is shown in a search engine environment 110. The search query transformation system 100 resides on a computing device 120. It should be noted that the computing device 120 may include a single processor (such as a desktop or laptop computer) or several processors and computers connected to each other.

The computing device 120 includes the search query transformation system 100, a search engine browser 130 for processing search requests, an initial search results list 135 generated by the search engine 130 and residing on the browser 130, and a revised search results list 140. The initial search results list 135 contains a list of search results that are ranked according to relevance of a user-supplied search query. The search results are Web pages that searcher using the search engine browser 130 can hyperlink to by clicking on a certain search result.

The computing device 120 is connected to a network 150. Also connected to the network 150 are a first computer 160 and a second computer 165. The first computer 160 includes a first display device 170 and first input device (such as a first keyboard 175) that allows a first user 180 to submit search queries and obtain search results based on the queries. Similarly, the second computer 165 includes a second display device 185 and a second input device (such as a second keyboard 190) that allows a second user 195 to interface with the search engine 130. Assume that the first user 180 is a skilled searcher (on a continuum of search expertise levels) and the second user 195 is a novice searcher. Based on this information, the search engine browser 130 augmented by the search query transformation system 100 could be displayed on the second display device 185 since novice searchers would greatly benefit from this arrangement. On the other hand, since the first user 180 is a skilled searcher, the browser displayed on the first display device 170 may not include the search query transformation system 100. However, the first user's search behavior may be logged by the system 100 to aid in suggesting search queries to the second user 185 (the novice searcher).

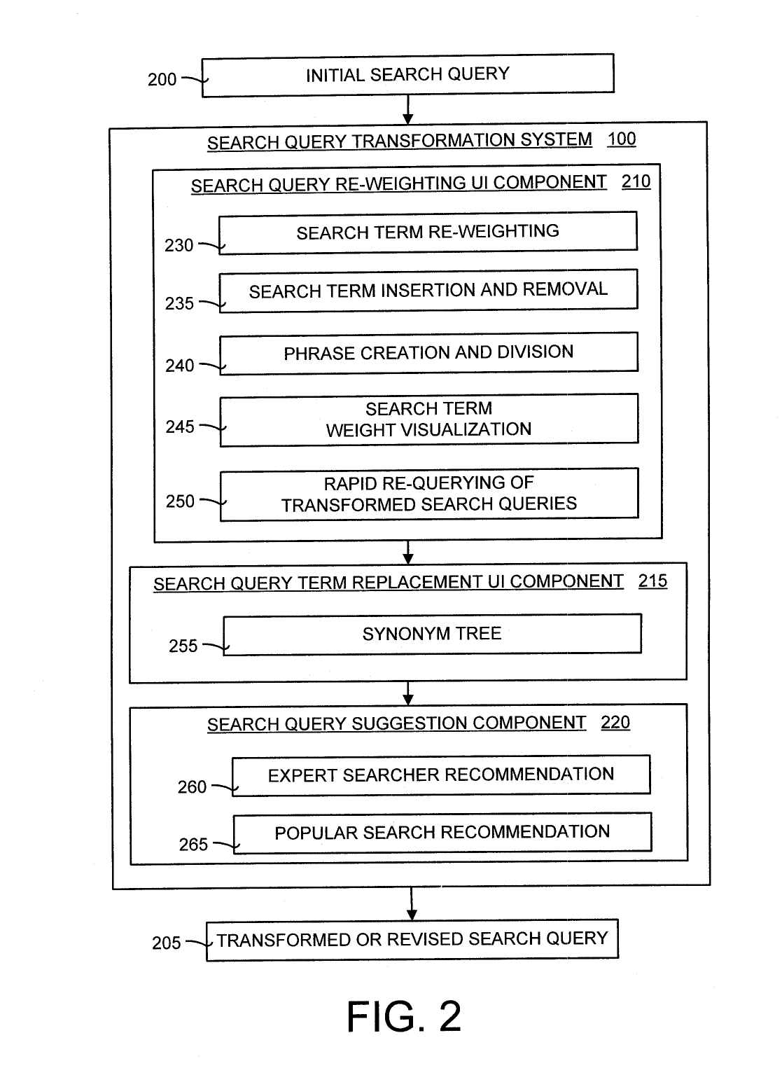

FIG. 2 is a block diagram illustrating an exemplary implementation of the search query transformation system 100 shown in FIG. 1. As explained in detail below, the search query transformation system 100 can use a variety of features and controls to transform and refine a search query. In general, a searcher submits an initial search query 200 to the system 100. The system 100 then refines the initial search query 200 based on a searcher's inputs, and then outputs a transformed or revised search query 205.

Instead of using advanced syntax or careful term-by-term query modification, embodiments of the system 100 include interface mechanisms that allow rapid query iteration and refinement using a pointing device (such as a mouse). Embodiments of the system 100 use the principle of “direct manipulation.” Direct manipulation means that objects of interest can be directly manipulated by a user through actions that correspond at least loosely to the physical world. Direct manipulation is characterized by rapid, reversible, incremental actions and immediate feedback.

The system 100 includes a search query re-weighting user interface (UI) component 210, a search query term replacement UI component 215, and a search query suggestion component 220. Generally, the search query re-weighting user interface (UI) component 210 allows a searcher to adjust weights of search terms already in initial search query 200 through a graphical user interface. The search query term replacement UI component 215 allows the searcher to replace search query terms with other terms, possibly by showing the searcher synonyms for a search term. The searcher interacts with this component 215 through a graphical user interface. Finally, the search query suggestion component 220 allows the searcher to obtain recommendations for search query revisions based on how others have revised their search queries.

The search query re-weighting UI component 210 includes a variety of components and controls that it can use in a graphical user interface environment. In particular, the searcher can perform graphical search term re-weighting 230 that reassigns weights of search query terms, and can perform graphical search term insertion and removal 235. The UI component 210 also can allow a searcher to perform phrase creation and division 240 to create phrases from the search query terms and also divide them. Search term weight visualization also may be used to present a visual indication to the searcher of how well the search query terms match search results. The UI component 210 also can achieve a rapid re-querying of transformed search queries such that revised search results are provided quickly to the searcher.

The search query term replacement UI component 215 can include a synonym tree 255. The synonym tree 255 provides the searcher a way in which to replace search query terms in a graphical manner. The search query suggestion component 220 can propose query suggestions to the searcher that are tailored to the proposed direct manipulation interface with recommendations from at least two sources. In some embodiments a source is an expert searcher recommendation 260, where recommendations are provided based on expert searchers' searching behavior. In other embodiments a source is popular search recommendation 265, where the most popular search revisions from the system 100 are supplied to a searcher seeking to revise his search query.

It should be noted that numerous embodiments of the search query transformation system 100 are possible. For example, embodiments of the system 100 may include any combination of the search query re-weighting UI component 210, the search query term replacement UI component 215, and the search query suggestion component 220. Embodiments may include one, two, three, or all of these components in any variety or combination. Moreover, embodiments of the system 100 can include any combination of the components of the search query re-weighting UI component 210 and the search query suggestion component 220.

### II. Component and Functionality Details

As noted above, the search query transformation system and method can be implemented in a number of different embodiments. The components and controls along with their functionality for the embodiments of the system and method will now be discussed.

IIa. Search Term Re-Weighting User Interface Component

In some embodiments the search query transformation system 100 includes a search query re-weighting user interface (UI) component. The re-weighting UI component enhances a user's Web search query refinement through the direct manipulation of graphical representation of search query objects such as terms and advanced query operators. As stated above, these advanced query operators may include plus (+), minus (−), quotes (“ ”), “site:”, and “weight:”. In some embodiments the search query re-weighting UI component includes a slider. As used in this document, the term “slider” is meant to represent the broadest possible interpretation of the term. By way of example and not limitation, in certain embodiments a slider includes a knob or button that moves in a linear fashion (such as back and forth on a straight track), while in other embodiments a slider knob or button moves in a non-linear manner (such as on a circular track). Some of these embodiments are described below.

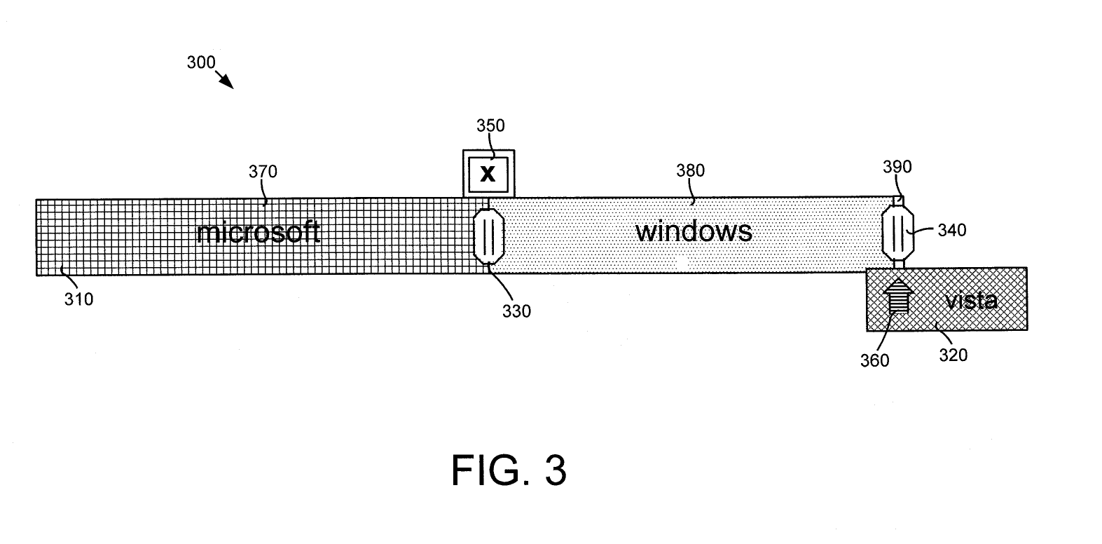

FIG. 3 illustrates a first embodiment 300 of the search query re-weighting user interface component that utilizes slider controls. As a searcher manipulates slider controls in the first embodiment 300, the search engine's internal representation of the query (which is hidden from the user) also changes to reflect the representation shown in the slider. In other words, the first embodiment 300 is a graphical representation of a search query that includes advanced operators.

In FIG. 3 is shown the first embodiment 300 of the search query re-weighting UI component as it might appear for the search query [microsoft windows−vista]. This search query uses the advanced operator minus “−”. This search query means that the terms “microsoft” and “windows” should appear in the retrieved documents but that the term “vista” should not appear. As will be described in detail below, another way of interpreting this search query is graphically using the first embodiment 300 of the search query re-weighting UI component. In this case, all search query terms should appear in the retrieved documents (“microsoft”, “windows”, and “vista”) and when ranking results that terms visible in search transformation box 310 (“microsoft” and “windows”) should be preferred over those terms in an search term exclusion box 320 (“vista”) under the search transformation box 310.

As shown in FIG. 3, the first embodiment 300 of the search query re-weighting UI component includes several controls. The search transformation box 310 includes a first slider 330 and a second slider 340. In general, for the first embodiment 300 of the search query re-weighting UI component there will be N-1 sliders, where N is the number of search query terms. The first embodiment 300 of the search query re-weighting UI component also includes a phrase creation button 350. The search term exclusion box 320 includes an insertion button 360. The operation of each of these controls is discussed below. This first embodiment 300 has the advantage of clearly illustrating to the searcher that all search term weights are relative.

In other embodiments the first slider 330 and the second slider 340 may have shapes that are different from those shown in FIG. 3. In addition, although as shown in FIG. 3 the first slider 330 and the second slider 340 have identical shapes, in other embodiments they may have shapes that are different from each other. Similarly, in some embodiments the phrase creation button 350 may have a different shape and orientation than shown in FIG. 3. For example, the phrase creation button 350 may be round and located under the search transformation box 310. Although the insertion button 360 is shown in FIG. 3 as an arrow on the left side of the search term exclusion box 320 in some embodiments the insertion button 360 may be rectangular and located on the right side of the search term exclusion box 320.

### IIa.1. Search Term Re-Weighting

The effects of manipulating each control now will be discussed. In general, the core functionality of the search query re-weighting UI component includes search term re-weighting, search term insertion and removal, and phrase creation and division. Search term re-weighting is accomplished using the first slider 330, the second slider 340, and the search transformation box 310. Moving slider buttons between terms changes the relative importance of each term and immediately submits the modified search query to the search engine, or causes the re-scoring of search results in browser 130 if client-side rearrangement of search results is supported (as discussed below). The size of the panel than encloses a search term is indicative of a relative weight assigned to each term. This relative weight translates to a numeric score that represents a search term value in relation to the other search terms. These weights are used to depict the importance of each search term and in the ranking of search results. For example, in FIG. 3 it can be seen that the search term “microsoft” is just as important as the search term “windows”. This is because a first panel 370 that encloses “microsoft” is the same size as a second panel 380 that encloses “windows”. In this case the search terms “microsoft” and “windows” have the same relative weight.

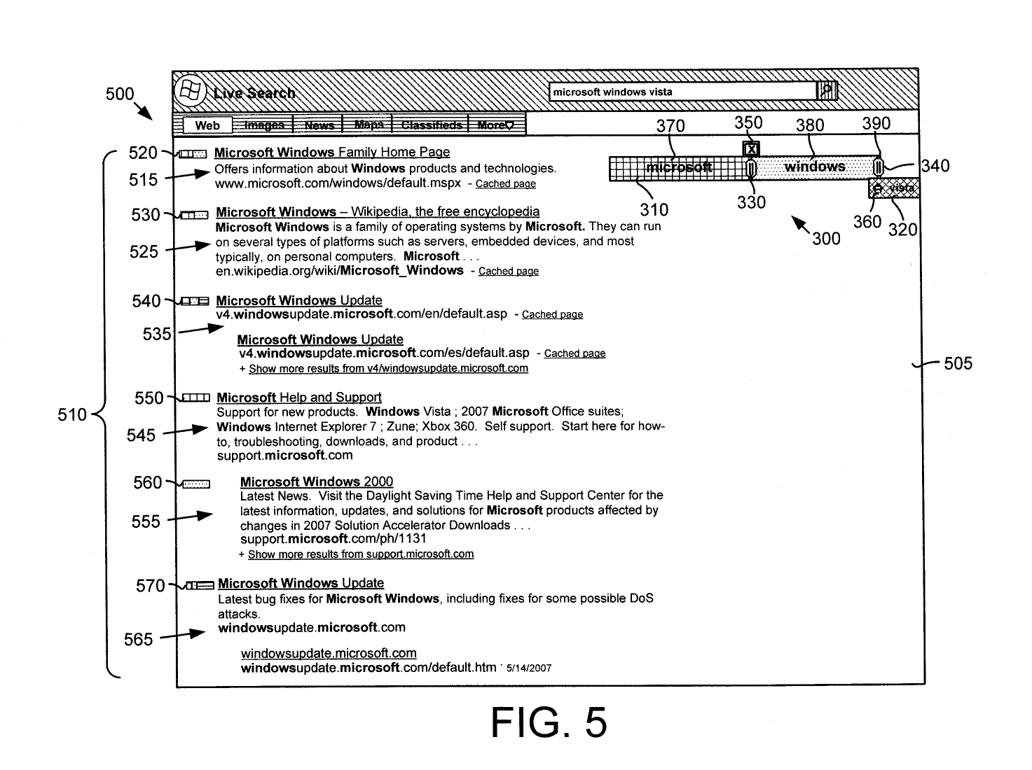

The panels 370, 380 of FIG. 3 also are meant to represent colors as a further visualization aid for the searcher. For example, the first panel 370 is the color red, which is represented as the small squares contained within. The second panel 380 is the color green, which is represented as small dots within. Although not shown, if the search term “vista” was in the search transformation box 310 the panel enclosing “vista” would be blue. This would be represented by horizontal lines within. This same convention is used throughout this document. For example, in FIG. 5 the weight bars (discussed below) use this convention to represent the colors red, green, and blue. It should be noted that in other embodiments different colors may be used.

### IIa.2. Search Term Insertion and Removal

Term removal and insertion also can be accomplished using the controls shown in FIG. 3. Note that the first slider 330 and the second slider 340 can be moved in a linear manner from left to right within the search transformation box 310. Term removal can be achieved by simply moving one or more sliders to reduce an amount of space a search term occupies in the search transformation box 310 to zero. This has the effect of excluding that particular search term from the query. This is similar to using the minus sign (“−”) advanced operator (or negation symbol) and gives priority to results that do not contain that excluded search term. Following the area reduction of a search term's panel to zero, the search term exclusion box 320 appears adjacent the removed search term. The search term exclusion box 320 gives the searcher the option to restore the removed search term to the search transformation box 310 using the insertion button 360. If the removed search term is not restored, it remains fixed adjacent the slider button from which it was removed. For example, in FIG. 3 the search term “vista” has been removed from the search transformation box 310 by moving the second slider 340 all the way to the right of the search transformation box 310 such that an area of a third panel 390 enclosing “vista” is reduced to nearly zero. The resulting search query shown in graphical form in FIG. 3 is equivalent in text form to a search for [“Microsoft windows”−vista].

In this particular implementation, it is assumed that the searcher wants to preserve at least one of the search terms in the original search query. In other words, the term removal and insertion feature does not allow the searcher to remove all search terms. In addition, in this embodiment it is assumed that each term that occupies space in the search transformation box 310 is required in the revised search query. The revised search query that would emerge from the first embodiment 300 of the search query re-weighting user interface component given the settings shown in FIG. 3 might be: [+(microsoft, weight: 0.5)+(windows, weight: 0.5)−vista]. It is highly improbable that a novice searcher would know sufficient detail about query syntax and advanced search operators to be able to compose such customized search queries. However, by utilizing the graphical nature of the search query re-weighting user interface component a novice user can easily construct such customized search queries.

### IIa.3. Phrase Creation and Division

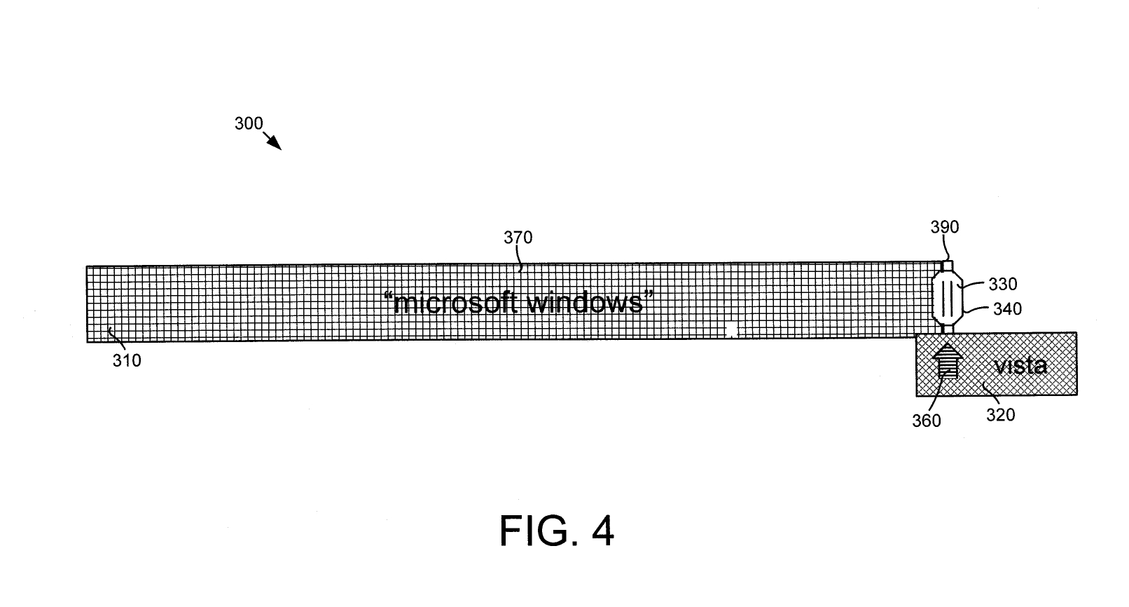

Phrase creation and division is another feature of the first embodiment 300 of the search query re-weighting user interface component shown in FIG. 3. If a searcher clicks on the phrase creation button 350 located between any two search terms then a quoted phrase is created. In addition, in some embodiments the panels for each of the search terms are combined into a single panel and the new panel assumes the background color of the panel of the search term appearing first in the phrase. This phrase then is treated in the same way as a single term for result reordering purposes. Phrase division is achieved by inserting a cursor of a pointing device between the search terms in the phrase. Clicking between the search terms of the phrase automatically divides the phrase into its constituent two search terms. Moreover, each divided search term is enclosed in its own panel along with its own background color. For example, in FIG. 3 depressing the phrase creation button 350 would create the phrase “microsoft windows”. FIG. 4 illustrates the first embodiment 300 of the search query re-weighting user interface component shown in FIG. 3 after using the phrase creation button to link two terms into a single phrase. The in textual form, the search query represented by the search query shown in FIG. 4 becomes [“Microsoft windows”−vista]. Clicking the space between the two terms would return the search terms to their original, divided state (“microsoft” and “windows”).

### IIa.4. Search Term Weight Visualization

FIG. 5 illustrates a search term weight visualization component 500 implemented in a web browser 505 along with search results 510 and the first embodiment 300 of the search query re-weighting user interface component shown in FIG. 3. The weight bars to the left of each search result depict the relationship between the search terms in the search query and how well those terms match the results displayed. Colored regions in each weight bar correspond to the colors associated with search terms in the search transformation box 310. By way of example, referring to a first search result 515 in FIG. 5, a first weight bar 520 is colored about half red and half green. This indicates that the search terms “microsoft” and “windows” shown in the search transformation box 310 match this first search result 515 equally well. Similarly, a second search result 525 has a corresponding second weight bar 530 that is color about half red and half green, having the same meaning as the first weight bar 520.

A third search results 535 has a corresponding third weight bar 540 that is colored about one-third red, one-third green, and one-third blue. This means that the search terms “microsoft”, “windows”, and “vista” match this third search result 535 equally well. In contrast, a fourth search result 545 has a corresponding fourth weight bar 550 that is almost entirely red. This indicates that the search term “microsoft” matched extremely well but that the search term “windows” did not match the fourth search result 545 very well. Similarly, a fifth search result 555 includes a corresponding fifth weight bar 560 that is almost entirely green. This means that the search term “windows” matched quite well but that the search term “microsoft” did not match the fifth search result 555 very well. A sixth search result 565 includes a corresponding sixth weight bar 570 that contains a small amount of red, a small amount of green, and is mostly blue. This indicates that the search terms “microsoft” and “windows” did not match the sixth search result 565 very well, but that the search term “vista” matched much better as compared to “microsoft” and “windows”.

The search term weight visualization component 500 shown in FIG. 5 can be particularly helpful in helping novice searchers understand which query search terms were most useful in finding search results that they consider to be relevant, and in better understanding why particular results were retrieved. This also has the additional positive effect of helping novice searchers to improve future search queries.

### IIa.5. Rapid Re-Querying of Transformed Search Queries

As a searcher uses the search query re-weighting UI component and moves sliders and forms phrases between search terms, the list of search results instantly updates to reflect the current slider position (and the internal query representation created by the slider settings). This real-time visual feedback allows the searcher to make more informed (and immediate) choices about whether her search query has been effective in retrieving relevant information. This is much better than having to resubmit her search query several times to a search engine and wait for a response. The direct and immediate relationship that exists between the position of the sliders and the grouping of search terms and the results these components are manipulating allows users to rapidly explore the space of retrieved search results.

Revising the search query can potentially generate dozens of new queries per second. Submitting queries to search engines at this rate is not yet practical. In some embodiments of the search query re-weighting UI component, a separate list of “popular destinations” that other searchers have visited is manipulated. This mitigates the need to contact the search engine at each iteration, as the list of destinations is based on cached interaction log data not search engine results. In other embodiments, rapid re-querying is achieved by batching several queries for nearby positions of each slider and submitting them proactively to the search engine. This allows search results for many possible UI interactions to be pre-cached and ready for immediate viewing. In yet another embodiment of rapid re-querying, a large but practical number of search results (on the order of about 1000 search results) are requested from the search engine. These search results then are re-ranked locally according to the search term weighting as the searcher manipulates the search query re-weighting UI component. New queries with appropriately modified weights can be resubmitted in the background at a maximum possible rate.

### IIa.6. Additional Embodiments

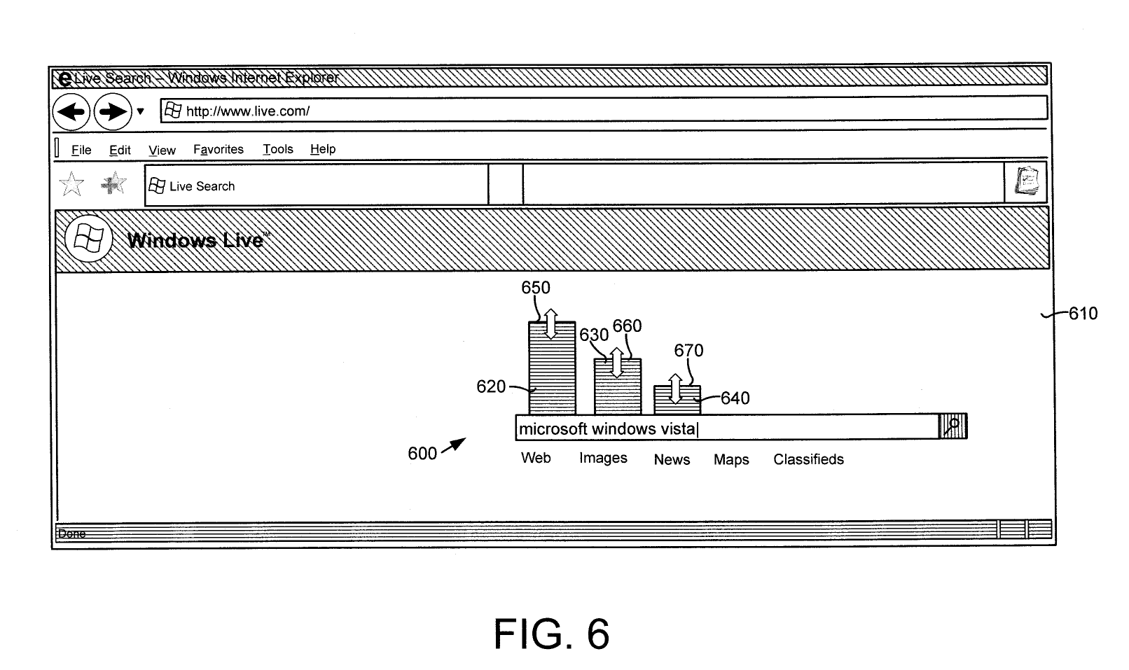

FIG. 6 illustrates a second embodiment 600 of the search query re-weighting user interface component that utilizes bar graph. As shown in FIG. 6, the second embodiment 600 is shown integrated with a search engine browser 610. The second embodiment 600 separates each search term into separate elements. Namely, the search term “microsoft” is represented by a first box 620, “windows” is represented by a second box 630, and “vista” is represented by a third box 640. Dragging the top of each box up or down increases the relative weighting of the search query terms positioned directly beneath the box. For example, dragging a first top 650 up or down (as shown by the arrow) changes the relative weight of “microsoft”, dragging a second top 660 up or down change the relative weight of “windows”, and dragging a third top 660 up or down changes the relative weight of “vista”. This second embodiment 600 has the advantage of allowing a more natural integration into the traditional search text box.

In FIG. 6 each of the three boxes 620, 630, 640 are represented by the same color. It should be noted that in other embodiments the three boxes 620, 630, 640 may each be a different color. For example, the colors may be the same as shown in FIG. 3, such that the first box 620 is red, the second box 630 is green, and the third box 640 is blue. Of course, other embodiments may use different colors or may forego colors altogether and merely use the relatively height of the boxes 620, 630, 640 to convey necessary information.

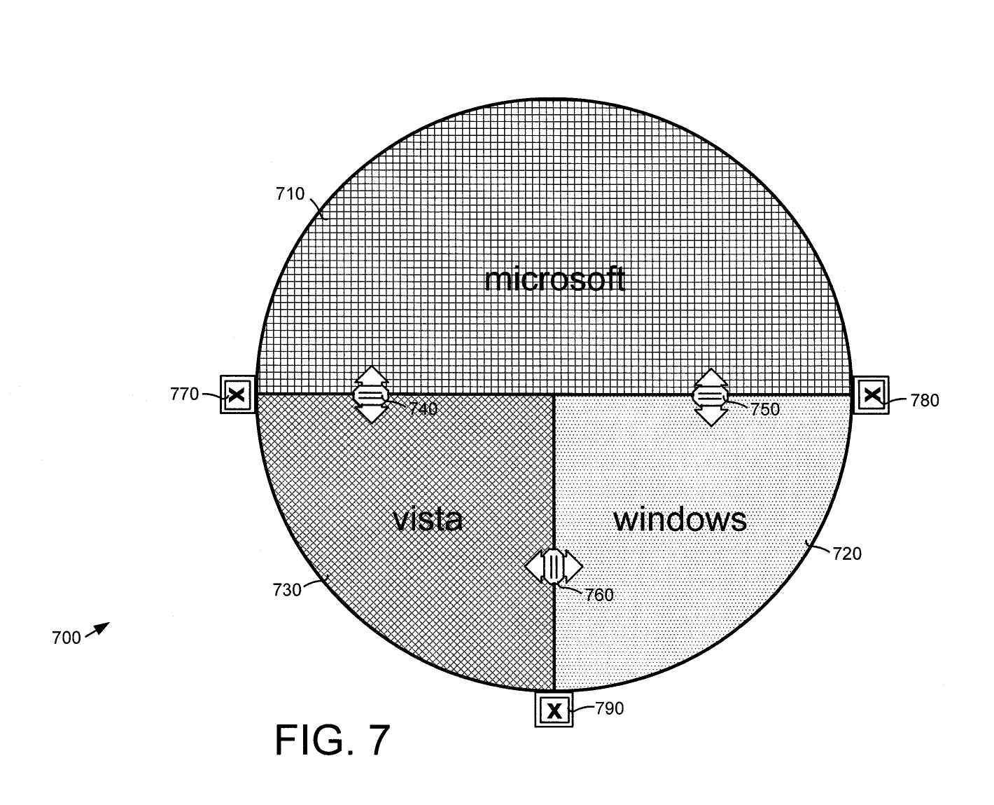

FIG. 7 illustrates a third embodiment 700 of the search query re-weighting user interface component that utilizes a pie chart. As shown in FIG. 7, the third embodiment 700 divides the search terms into section of the pie chart. For example, a first section 710 includes the search term “microsoft” (which takes up 50% of the pie chart), a second section 720 includes the search term “windows” (which occupies 25% of the pie chart), and a third section 730 includes the search term “vista” (which also occupies 25% of the pie chart).

In addition, the third embodiment 700 includes N sliders, where N is the number of search query terms. As shown in FIG. 7, the third embodiment includes a first slider 740, a second slider 750, and a third slider 760. The sliders 740, 750, 760 move in a circular path (in the direction indicated by the arrows) and allow a searcher to graphically adjust the relative weights of each of the search terms. The third embodiment 700 also includes a first phrase creation button 770, a second phrase creation button 780, and a third phrase creation button 790. Similar to the phrase creation buttons of the first embodiment 300, the phrase creation buttons 770, 780, 790 allow the searcher to join two search terms into a single phrase with quotes around the phrase.

IIb. Search Query Term Replacement User Interface Component

The search query re-weighting UI component described above provides a direct-manipulation user interface for refining queries by manipulating search term weights and phrasing. However, the component does not allow rapid substitution of search query terms with other search query terms. In the same scenarios for which sliders are beneficial (such as for allowing novice searchers to refine their queries and for allowing rapid query refinement when typing is cumbersome), it is desirable to provide a searcher with a graphical way in which to rapidly substitute search terms.

To this end, in some embodiments the search query transformation system 100 includes a search query term replacement user interface (UI) component. In some embodiments this UI is a direct-manipulation user interface component called a “synonym tree”. The synonym tree allows rapid, keyboard-free, in-place replacement of search query terms with suggested substitutions. Note that while this is similar to the “suggested queries” functionality currently available from major search engines, that functionality operates only on a whole-query level. In contrast, the synonym tree allows more subtle refinement of queries, thus allowing an easier way to refine or expand an existing search query.

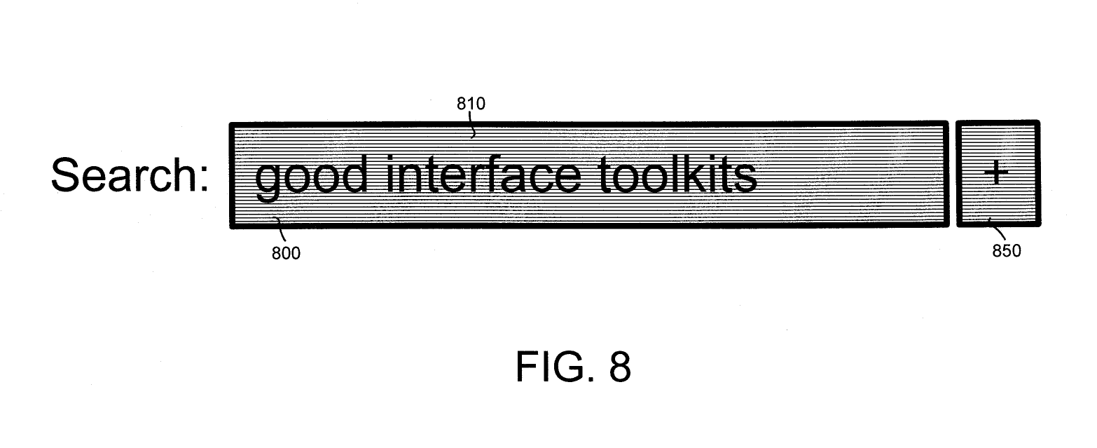

FIG. 8 illustrates one embodiment of the search query term replacement UI components integrated into a search text box 800 containing a synonym tree functionality. In FIG. 8 an initial search query 810 has already been typed into the box 800. A search engine will return a search results list. If a searcher is not satisfied with the search results, he can begin the refinement process by clicking on any of the terms in his initial search query 810. This will begin the refinement process using the synonym tree.

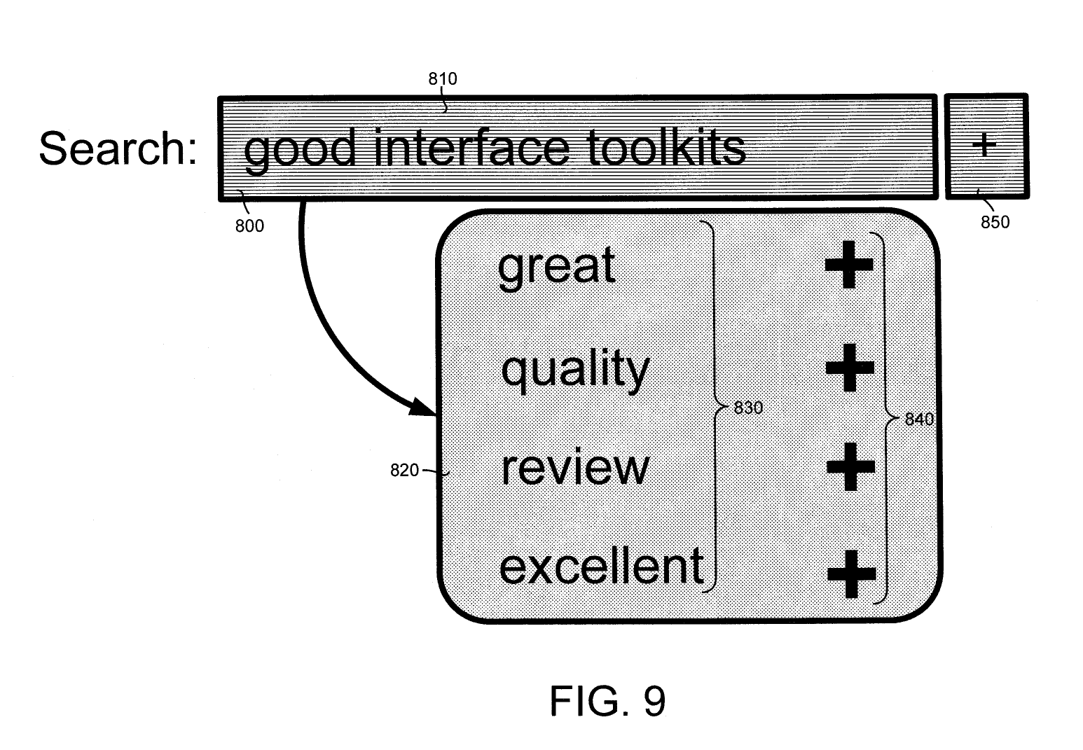

FIG. 9 illustrates the embodiment of FIG. 8 during the search query refinement process. In particular, the searcher has indicated a desire to refine his initial search query 810 by clicking on the term “good”. This makes the synonym tree 820 appear along with a list of suggested synonyms 830. Clicking on any of the suggested synonym terms (such as “great”, “quality”, “review”, or ‘excellent’) will replace the term “good” in the initial search query 810 to generate a revised search query. By clicking on one of a set of plus signs (“+”) 840 to the right side and adjacent any of the suggested synonym terms will add that term to the initial search query 810 preceded by an “or” operator. Clicking a search text box plus sign “+” sign 850 located adjacent and search text box 810 will bring up a list of suggested additions to the initial search query 810.

By way of example, if the searcher clicks on the synonym term “great”, the revised search query would be [good great interface toolkits]. On the other hand, if the searcher clicks on the plus sign next to the synonym term “great”, then the revised search query would be [(good or great) interface toolkits]. This is a very important search query pattern that is currently difficult to build in most search interfaces. The search typically does not care in this case whether he finds the word “great” or “good”, only that there is a positive sentiment expressed with one of these words. The synonym tree 820 makes it easy to rapidly expand the initial search query 810 by “or'ing together” words that are semantically equivalent to the user, requiring that the search results contain any of the equivalent terms, and thereby improving result coverage.

The synonym tree 820 presents a set of search terms that the system 100 determines are suitable replacements for this term in the initial search query 810. In some embodiments of the synonym tree 820, search terms are drawn from a thesaurus (a list of words that are similar according to language semantics), from a list of common replacements observed in previous queries, or both. Selection made from a list of common replacements observed in previous queries allows the synonym tree 820 to choose terms that are appropriate replacements according to the semantics of the Web, rather than just the semantics of the language. In this example, a thesaurus might tell us that “great” or “excellent” are synonyms for “good”, but an experienced Web searcher might in fact choose to replace “good” with “review”, which we can determine from search query logs but not from a thesaurus. In some embodiments this type of replacement suggestion can be particularly drawn from search query logs corresponding to expert Web searchers who have a strong understanding of this “Web semantics” replacement strategy.

Note that because only a finite set of possible replacement queries exist for a given search query, it is possible for the system 100 to begin pre-fetching all possible replacement queries immediately after the searcher executes a revised search query, allowing very rapid interaction. For example, when the searcher submitted the query “good interface toolkits”, the system 100 would concurrently submit the queries “excellent interface toolkits”, “great interface toolkits”, and so forth. When the searcher clicks on one of the terms, an additional set of queries can be speculatively executed, including probably combinations of terms, such as [(great or good or review) interface toolkits].

IIc. Search Query Suggestion Component

Some embodiments of the search query transformation system 100 include a search query suggestion component. In a first embodiment of the search query suggestion component is an expert searcher recommendation. This embodiment uses the queries of expert searchers to recommend possible settings for the sliders, or appropriate content for the synonym tree. While current search systems provide “query suggestion” (popular queries offered to users for query refinement), this embodiment offers “advanced query suggestions” that are the most popular versions of the current query that include advanced operators translated into the query abstraction offered by the slider. In other words, this would convey the recommended settings for the system 100 without the need for many searchers to interact with it to generate these data. In other words, this would effectively translate queries submitted by more expert searchers into a visual representation that may be more easily understood by novice searchers. For example, if experts often type a query like [+(microsoft, weight:0.6)+(windows, weight: 0.4)−vista], the query slider can show this query to novices as a suggested new query without exposing the complex syntax. Similarly, “or” groupings made frequently by expert searchers could result in visual highlights on the plus-signs in the synonym tree 820, alerting novice searchers that expert searchers frequently “or” these terms together, without having to explain or show complex Boolean syntax.

Another embodiment of the embodiment of the search query suggestion component is a popular search recommendation. This embodiment presents information on how sliders in the system 100 are being used by many other searchers for the current query. In other words, the most popular settings of the system 100 from many searchers for a particular search query. In some embodiments, this is represented as a line graph with the peaks representing the most used positions for the slider buttons. Query suggestions (typically offered as a list of options separate from the search results) can also be integrated into this embodiment, making the query reformulation process more consistent and removing the unnecessary separation that exists between query entry and query suggestions on many current Web interfaces.

### III. Exemplary Operating Environment

Embodiments of the search query transformation system and method are designed to operate in a computing environment. The following discussion is intended to provide a brief, general description of a suitable computing environment in which embodiments of the search query transformation system and method may be implemented.

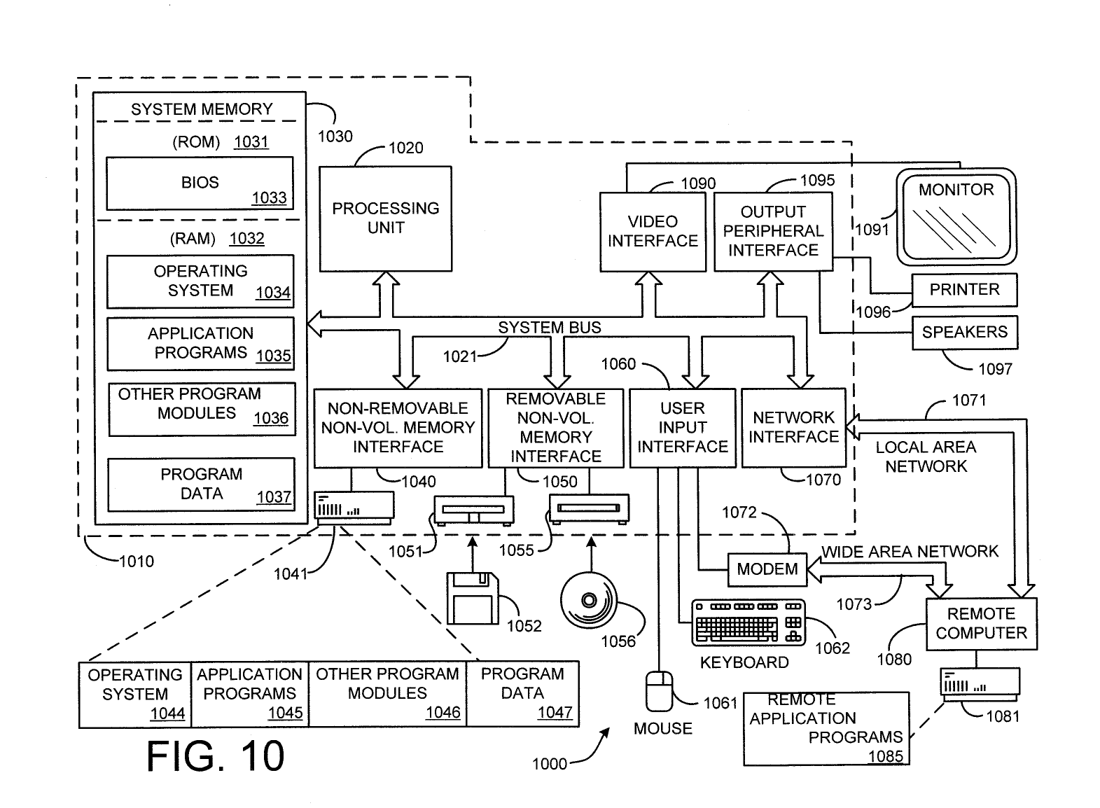

FIG. 10 illustrates an example of a suitable computing system environment in which embodiments of the search query transformation system and method shown in FIGS. 1-9 may be implemented. The computing system environment 1000 is only one example of a suitable computing environment and is not intended to suggest any limitation as to the scope of use or functionality of the invention. Neither should the computing environment 1000 be interpreted as having any dependency or requirement relating to any one or combination of components illustrated in the exemplary operating environment.

Embodiments of the search query transformation system and method are operational with numerous other general purpose or special purpose computing system environments or configurations. Examples of well known computing systems, environments, and/or configurations that may be suitable for use with embodiments of the search query transformation system and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Embodiments of the search query transformation system and method may be described in the general context of computer-executable instructions, such as program modules, being executed by a computer. Generally, program modules include routines, programs, objects, components, data structures, etc., that perform particular tasks or implement particular abstract data types. Embodiments of the search query transformation system and method may also be practiced in distributed computing environments where tasks are performed by remote processing devices that are linked through a communications network. In a distributed computing environment, program modules may be located in both local and remote computer storage media including memory storage devices. With reference to FIG. 10, an exemplary system for embodiments of the search query transformation system and method includes a general-purpose computing device in the form of a computer 1010 (the computing device 120, first computer 160, and second computer 165 are examples of the computer 1010).

Components of the computer 1010 may include, but are not limited to, a processing unit 1020 (such as a central processing unit, CPU), a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 1010 typically includes a variety of computer readable media. Computer readable media can be any available media that can be accessed by the computer 1010 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 1010. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1040 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within the computer 1010, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable, volatile/nonvolatile computer storage media. By way of example only, FIG. 10 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies. A user may enter commands and information (or data) into the computer 1010 through input devices such as a keyboard 1062, pointing device 1061, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 1020 through a user input interface 1060 that is coupled to the system bus 1021, but may be connected by other interface and bus structures, such as, for example, a parallel port, game port or a universal serial bus (USB). A monitor 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1010 may operate in a networked environment using logical connections to one or more remote computers, such as a remote computer 1080. The remote computer 1080 may be a personal computer, a server, a router, a network PC, a peer device or other common network node, and typically includes many or all of the elements described above relative to the computer 1010, although only a memory storage device 1081 has been illustrated in FIG. 10. The logical connections depicted in FIG. 10 include a local area network (LAN) 1071 and a wide area network (WAN) 1073, but may also include other networks. Such networking environments are commonplace in offices, enterprise-wide computer networks, intranets and the Internet.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. The modem 1072, which may be internal or external, may be connected to the system bus 1021 via the user input interface 1060, or other appropriate mechanism. In a networked environment, program modules depicted relative to the computer 1010, or portions thereof, may be stored in the remote memory storage device. By way of example, and not limitation, FIG. 10 illustrates remote application programs 1085 as residing on memory device 1081. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A search query transformation system for transforming and revising an initial search query having search terms, comprising:
a search query re-weighting user interface component that allows a searcher to adjust a weight of query operators in the initial search query to obtain search query re-weighting revisions;
a search query term replacement user interface component that allows the searcher to replace individual terms or individual phrases in the initial search query to obtain search query term replacement revisions; and
a revised search query that is a combination of the search query re-weighting revisions and the search query term replacement revisions.

2. The search query transformation system of claim 1, further comprising a search term insertion and removal component that allows the searcher to remove and re-insert removed search terms into the revised search query.

3. The search query transformation system of claim 1, the search query re-weighting user interface component further comprising a bar graph or a pie graph.

4. The search query transformation system of claim 1, further comprising a search term weight visualization component including weight bars adjacent to each search result in a search results list for the initial search query that indicates how well the search terms match with each search result.

5. The search query transformation system of claim 1, further comprising a rapid re-querying of transformed search queries that provides real-time search results for the revised search query.

6. The search query transformation system of claim 1, further comprising a synonym tree located in the search query term replacement user interface component containing a list of suggested synonyms for a search term that the searcher has clicked on in a search text box containing the initial search query.

7. The search query transformation system of claim 6, further comprising a functionality that allows the searcher to add one of the list of suggested synonyms to the initial search query preceded by an “or” operator.

8. The search query transformation system of claim 1, further comprising a search query suggestion component that provides recommendations to the searcher for revising the initial search query.

9. The search query transformation system of claim 8, further comprising an expert searcher recommendation component that recommends to the searcher which advanced search operators and synonym search terms to use in the revised search query based on a log of expert searchers' querying behavior.

10. The search query transformation system of claim 9, further comprising a suggested new query that is based on a search conducted by an expert searcher, the suggested new query displayed to the searcher on a query slider.

11. The search query transformation system of claim 8, further comprising a popular search recommendation component that recommends to the searcher which advanced search operators and synonym search terms to use in the revised search query based on popular settings of the system as determined from a log of previous searchers' interaction with the system.

12. A graphical user interface for transforming search terms contained in an initial search query, comprising:
a search transformation box containing at least some of the search terms;
sliders in the search transformation box that allow a searcher to adjusts search weights of the search terms in the search transformation box; and
a search term exclusion box adjacent the search transformation box has an effect of using the minus (“−”) advanced search operator.

13. The graphical user interface of claim 12, further comprising a phrase creation button located adjacent each slider that puts two search terms located on either side of the phrase creation button in quotation marks to generate a transformed search query.

14. The graphical user interface of claim 13, further comprising an insertion button located in the search term exclusion box that inserts an excluded search term in the search term exclusion box back into the search transformation box.

15. The graphical user interface of claim 14, further comprising a first panel in the search transformation box that contains a first search term and represents a first weight of the first search term relative to other search terms in the search transformation box.

16. The graphical user interface of claim 15, further comprising a search engine browser containing a search text box with the initial search query therein having the search transformation box and search term exclusion box incorporated therein.

17. A graphical user interface for replacing terms and phrase in an initial search query, comprising:
a search text box containing the initial search query;
a search term in the search text box that a searcher can click on when the searcher desires alternate search terms;
a synonym tree containing a list of suggested synonyms that appears when the searcher clicks on the search term; and
a synonym in the list of suggested synonyms that replaces the search term with the synonym when the searcher clicks on the synonym to generate a revised search query.

18. The graphical user interface of claim 17, further comprising a plus sign adjacent the synonym that adds the synonym to the initial search query along with an “or” operator between the search term and the synonym.

19. The graphical user interface of claim 18, further comprising a search text box plus sign adjacent the search text box that provides a list of suggested additions to the initial search query when the searcher clicks on the search text box plus sign.

20. The graphical user interface of claim 19, further comprising a thesaurus that provides the list of suggested synonyms from search query logs of expert searchers.
